(19) United States
(12) Patent Application Publication
(10) Pub. No.: US 2008/0282443 A1
(43) Pub. Date: Nov. 20, 2008

(54) PROTECTIVE GARMENT WITH HYBRID SLEEVE SEAM

(75) Inventors: Nicholas J. Curtis, Middletown, OH (US); Margaret Diane Best, Beattyville, KY (US)

Correspondence Address: THOMPSON HINE L.L.P.;Intellectual Property Group, P.O. BOX 8801, DAYTON, OH, 45401-8801, US

(73) Assignee: LION APPAREL, INC., Dayton, OH (US)

(21) Appl. No.: 12/122,169

(22) Filed: May 16, 2008

Related U.S. Application Data
(60) Provisional application No. 60/938,760, filed on May 18, 2007.

(51) Int. Cl. A62B 17/00; A41D 3/02; A41D 27/24; A41D 27/00

(52) U.S. Cl. 2/81; 2/85; 2/97; 2/98; 2/275; 2/243.1

(57) ABSTRACT

A protective garment including a body portion having a front and a back, and a sleeve. The sleeve is coupled to the front of the body portion by a raglan seam and coupled to the back of the body portion by an inset seam.

This application claims priority to U.S. Provisional Application Ser. No. 60/938,760, filed on May 18, 2007, the entire contents of which are hereby incorporated by reference.

This application relates to garments, and more particularly, to a sleeve seam for protective garments.

### BACKGROUND

Protective or hazardous duty garments are used in a variety of industries and settings to protect the wearer from hazardous conditions such as heat, smoke, cold, sharp objects, chemicals, liquids, fumes and the like. Such protective or hazardous duty garments are often used in adverse conditions, such as high temperatures, exposure to flame, smoke, chemicals and the like. In addition, the wearers of such garments are typically placed under physical strain by carrying heavy gear and equipment. Wearers seek to avoid fatigue to remain mentally sharp and physically ready to carry out tasks.

Protective garments are often constructed from sturdy and stiff materials to provide sufficient protection to the wearer. However, the stiffness of these materials may prevent the garment from freely moving and flexing, and the weight of the garment can fatigue the wearer. Accordingly, there is a need for a protective garment that can reduce stress upon the wearer. There is also a need for a protective garment with relative little hemrise to ensure adequate protection to the wearer.

### SUMMARY

In one embodiment, the invention is a protective garment including a body portion having a front and a back, and a sleeve. The sleeve is coupled to the front of the body portion by a raglan seam and coupled to the back of the body portion by an inset seam.

In another embodiment, the invention is a method for making a protective garment including the step of providing a body portion having a front and a back. The method further includes the step of coupling a sleeve to the front of the body portion by a raglan seam and to the back of the body portion by an inset seam.

### BRIEF DESCRIPTION OF THE DRAWINGS

FIG. 1 is a front perspective view of one embodiment of the garment of the present invention, shown in the form of a coat with certain layers cut away for illustrative purposes;

FIG. 2 is a front view of the coat of FIG. 1;

FIG. 3 is a side view of the coat of FIG. 1 with the sleeve lowered;

FIG. 3A is a side view of the coat of FIG. 3, with the sleeve slightly raised to show expansion of the pleat;

FIG. 4 is a back view of the coat of FIG. 1;

FIG. 5 is a side perspective view of a sleeve exploded away the body; and

FIG. 6 is a front perspective view of the coat of FIG. 1, with the inner liner exploded away.

### DETAILED DESCRIPTION

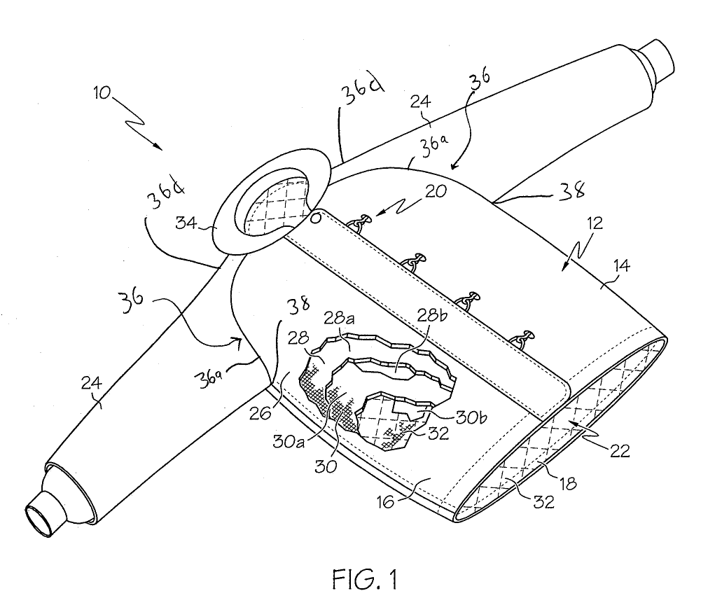

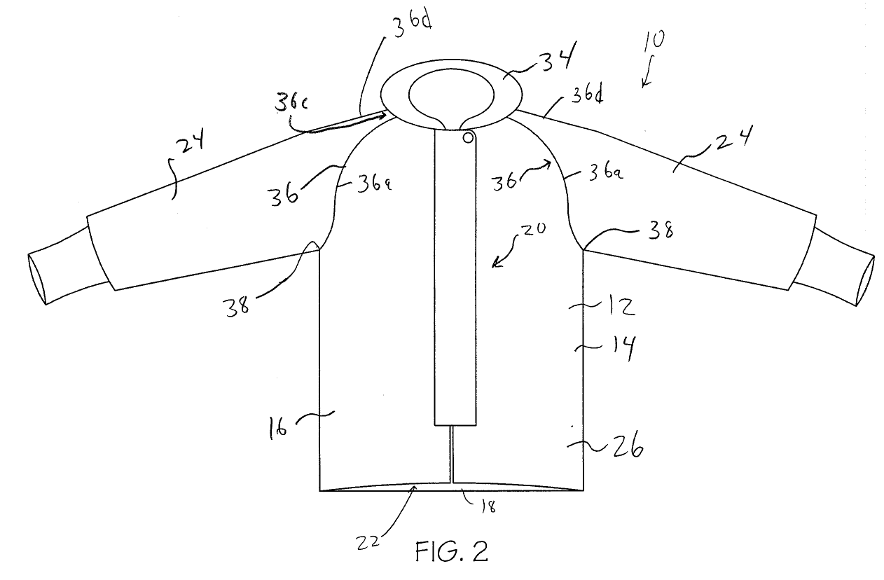

FIG. 1 illustrates a protective or hazardous duty garment in the form of a firefighter's coat, generally designated 10. The coat 10 includes a body portion 12 which receives the torso of a wearer therein. The body portion 12 may have a left front panel 14, right front panel 16 and a back panel 18. The left front panel 14 and right front panel 16 may be releasably attachable by a fastener 20, such as a zipper, snaps, clasps, clips, hook-and-loop fastening material (i.e., VELCRO® festinating material) combinations of these components or the like. The panels 14, 16 are completely detachable from each other along their entire heights to aid in donning and doffing of the garment 10. The body portion 12 may define a torso cavity 22 that is shaped to receive a wearer's torso therein. The coat 10 may include a pair of arms or sleeves 24 coupled to and extending generally outwardly from the body portion 12 and shaped to receive a wearer's arms therein and cover at least about 90% of the arms of an average sized adult wearer.

The coat 10 may include various layers through its thickness to provide various heat, moisture and abrasion resistant qualities to the coat 10 so that the coat 10 can be used as a protective, hazardous duty, and/or firefighter garment. For example, in one embodiment the coat 10 may include an outer shell 26, a moisture barrier 28 located inside of and adjacent to the outer shell 26, a thermal liner or barrier 30 located inside of and adjacent to the moisture barrier 28, and an inner liner or face cloth 32 located inside of and adjacent to the thermal liner 30.

The outer shell 26 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Del.), and commercially available polybenzamidazole fibers include PBI fibers (a trademark of PBI Performance Fabrics of Charlotte, N.C.). Thus, the outer shell 26 may be an aramid material, a blend of aramid materials, a polybenzamidazole material, a blend of aramid and polybenzamidazole materials, or other appropriate materials. If desired, the outer shell 26 may be coated with a polymer, such as a durable, water repellent finish (i.e. a perfluorohydrocarbon finish, such as TEFLON® finish sold by E. I. Du Pont de Nemours and Company of Wilimington, Del.). The materials of the outer shell 26 may have a weight of, for example, between about 5-10 oz/yd².

The moisture barrier 28 and thermal liner 30 may be generally coextensive with the outer shell 26, or spaced slightly inwardly from the outer edges of the outer shell 26 (i.e., spaced slightly inwardly from the outer ends of the sleeves 24, the collar 34 and from the lower edge of the coat 10) to provide moisture and thermal protection throughout the coat 10. The moisture barrier 28 may include a semi-permeable membrane layer 28a and a substrate 28b. The membrane layer 28a may be generally moisture vapor permeable but generally impermeable to liquid moisture.

The membrane layer 28a may be made of or include expanded polytetrafluoroethylene (“PTFE”) such as GORE-TEX or CROSSTECH materials (both of which are trademarks of W.L. Gore & Associates, Inc. of Newark, Del.), polyurethane-based materials, neoprene-based materials, cross-linked polymers, polyamid, or other materials. The membrane layer 28a may have microscopic openings that permit moisture vapor (such as water vapor) to pass therethrough, but block liquids (such as liquid water) from passing therethrough. The membrane layer 28a may be made of a microporous material that is either hydrophilic, hydrophobic, or somewhere in between. The membrane layer 28a may also be monolithic and may allow moisture vapor transmission therethrough by molecular diffusion. The membrane layer 28a may also be a combination of microporous and monolithic materials (known as a bicomponent moisture barrier), in which the microporous or monolithic materials are layered or intertwined.

The membrane layer 28a may be bonded or adhered to a substrate 28b of a flame and heat resistant material to provide structure and protection to the membrane layer 28a. The substrate 28b may be or include aramid fibers similar to the aramid fibers of the outer shell 26, but may be thinner and lighter in weight. The substrate 28b may be woven, non-woven, spunlace or other materials. In the illustrated embodiment, the membrane layer 28a is located between the outer shell 26 and the substrate 28b. However, the orientation of the moisture barrier 28 may be reversed such that the substrate 28b is located between the outer shell 26 and the membrane layer 28a.

The thermal liner 30 may be made of nearly any suitable material that provides sufficient thermal insulation. In one embodiment, the thermal liner 30 may include a relatively thick (i.e. between about 1/16″- 3/16″) batting, felt or needled non-woven bulk or batting material 30a which can include aramid fiber batting (such as NOMEX batting), aramid needlepunch material, an aramid non-woven material, an aramid blend needlepunch material, an aramid blend batting material, an aramid blend non-woven material, or foam (either open cell or closed cell) materials. The batting 30a may trap air and possess sufficient loft to provide thermal resistance to the coat 10.

The batting 30a is typically quilted to a thermal liner face cloth 30b which can be a weave of a lightweight aramid material. Thus, either the batting 30a alone, or the batting 30a in combination with the thermal liner face cloth 30b, may be considered to constitute the thermal liner 30. In one embodiment, the thermal liner 30 (or the coat 10 as a whole) may have a thermal protection performance (“TPP”) of at least about twenty, and/or the coat 10 as a whole may have a TPP of at least about thirty-five. If desired, the thermal liner 30 may be treated with a water-resistant or water-repellent finish. In the illustrated embodiment, the batting 30a is located between the outer shell 26 and the thermal liner face cloth 30b. However, the orientation of the thermal liner 30 may be reversed such that the thermal liner face cloth 30b is located between the outer shell 26 and the batting 30a. Moreover, although the moisture barrier 28 is shown as being located between the outer shell 26 and the thermal liner 30, the positions of the moisture barrier 28 and thermal liner 30 may be reversed such that the thermal liner 30 is located between the outer shell 26 and the moisture barrier 28.

The face cloth 32 may be the innermost layer of the coat 10, located inside the thermal liner 30. The face cloth 32 can provide a comfortable surface for the wearer and protect the thermal liner 30 and/or moisture barrier 28 from abrasion and wear.

Each layer of the coat 10, and the coat 10 as a whole, may meet the National Fire Protection Association (“N.F.P.A.”) 1971 standards for protective firefighting garments (“Protective Clothing for Structural Firefighting”), which are entirely incorporated by reference herein. The NFPA standards specify various minimum requirements for heat and flame resistance and tear strength. For example, in order to meet the NFPA standards, the outer shell 26, moisture barrier 28 and thermal liner 30 must be able to resist igniting, burning, melting, dripping and/or separation at a temperature of 500° F. for at least five minutes. Furthermore, in order to meet the NFPA standards, all combined layers of the coat 10 must provide a thermal protective performance rating of at least thirty-five.

Each sleeve 24 may be attached to the body portion 12 along a seam, generally designated 36. Each seam 36 may be a combined/hybrid raglan and inset sleeve design. In particular, each seam 36 may include a raglan seam or seam portion 36a on the front of the coat 10, and an inset seam or seam portion 36b on the back of the coat 10. Each raglan seam portion 36a may begin at the center of the underarm portion 38 of the coat 10, and extend upwardly towards the collar 34 along the front of the coat 10 in a generally “quarter-circle” or 90 degree arc or shape. In other words, in front view, each raglan seam portion 36a may define an arc that extends from the underarm portion 38, generally upwardly and toward the collar 34, and is generally parallel to a shoulder of the garment 10 as the raglan seam portion 36a approaches the collar 34.

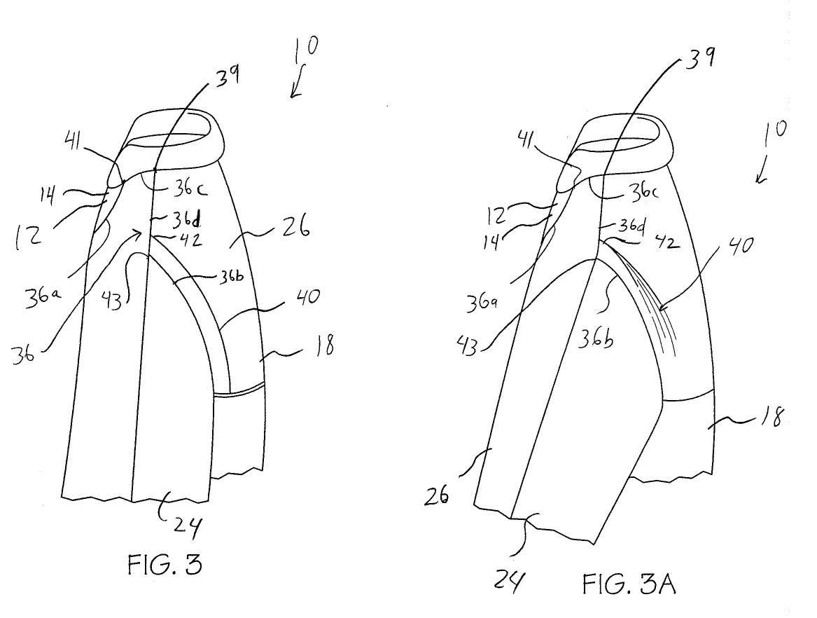

A first connecting seam portion 36c begins at the ending point 41 of the raglan seam portion 36a (see FIG. 3) and extends about the collar 34 in a generally circumferential direction until the first connection portion 36c terminates at the upper-most extent 39 of the shoulder. A second connecting seam portion 36d extends from point 39, downwardly along the upper ridge/shoulder of the coat 10 toward the distal end of the sleeve 24, and terminates at point 43.

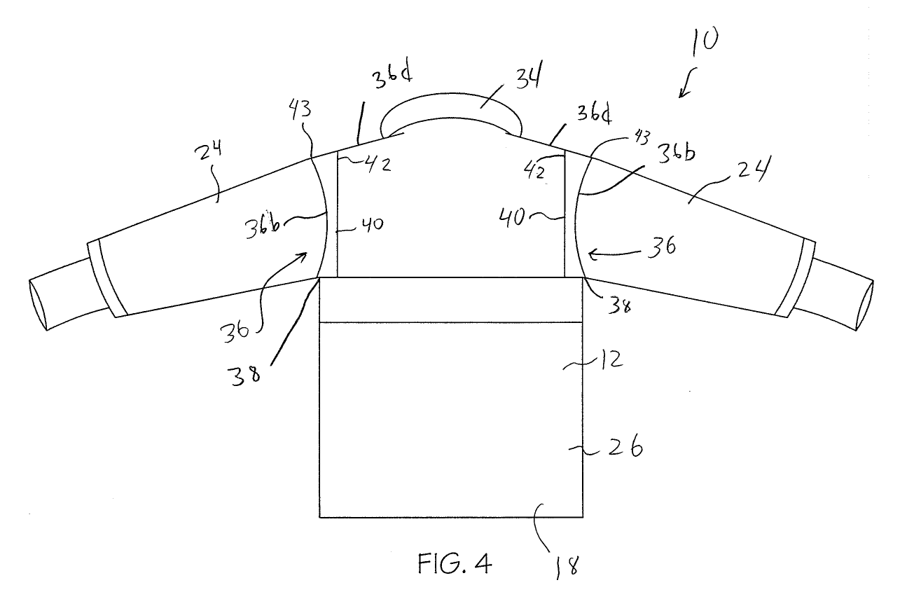

On the back side of the body portion 12 (FIG. 4), the inset sleeve seam portion 36b begins at the center of the underarm portion 38 of the coat 10, and extends generally directly upwardly (with a slightly concave curvature) until the inset seam portion 36b intersects the second connecting seam portion 36d. The concavity of the inset sleeve seam portion 36b may form a slight “C” shape, with the open mouth of the “C” facing away from the center of the garment, as can be seen in FIG. 4. The raglan seam portion 36a, inset seam portion 36b, and connecting seam portions 36c, 36d together define a generally closed loop about which each sleeve 24 is connected to the body portion 12.

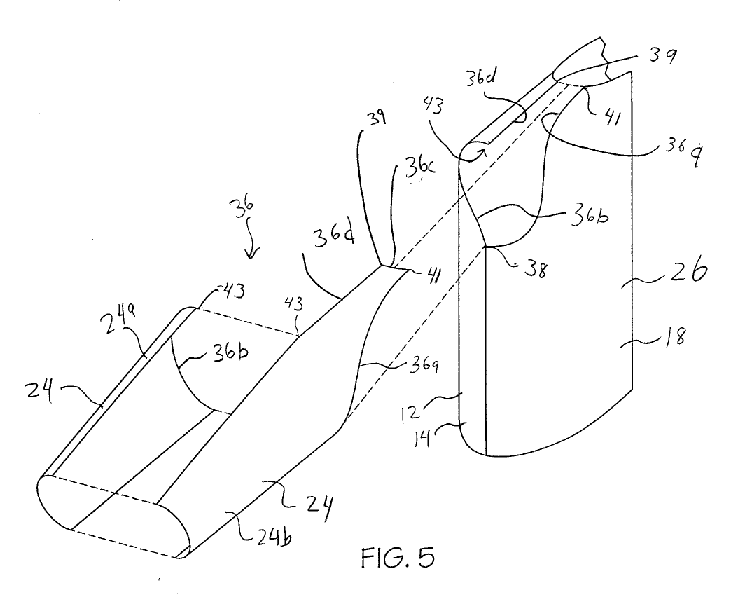

FIG. 5 illustrates one embodiment of the seam 36, with the sleeve 24 exploded away from the body 12 and the raglan sleeve seam portion 36a separated from the inset sleeve seam portion 36b. Although the sleeve 24 is shown as having a portion 24a having the raglan sleeve portion 36a and a separate portion 24b having the inset sleeve seam portion 36b, the sleeve portions 24a, 24b could be formed from a single seamless piece of material.

A pleat 40 (FIGS. 3, 3A and 4) may be positioned adjacent on the back 18 of the coat 10 and adjacent (i.e. within about 3″; or within about 20% or 30% of the width of the coat 10 across the shoulders; or closer to the seam 36 than to the vertical centerline of the coat 10) to an associated one of the seams 36. Each pleat 40 can take any of a variety of forms, but in general takes the form of a generally vertically-extending fold of overlapping material that is folded and stitched (i.e. along the upper portion 42 thereof) to maintain the pleat 40 in its folded state. Upon the application of forces in the lateral direction (i.e. across the shoulders of the coat 10, such as when a wearer leans forward, reaches forward, and/or raises his or her arms) the pleats 40 tend to unfold and allow expansion of the back 18 of the coat in the lateral direction, as shown in FIG. 3A. Once the application of forces in the lateral direction is removed, the pleats 40 will tend to return to their folded state and return the coat 10 to a more compact state.

The pleats 40 thus allow freedom of movement for the user. For example, when a user extends his or her arms upwardly and/or forwardly, the pleats 40 may unfold and increase the ease of the forward reach. Since the pleats 40 tend to return to their folded position the pleats 40 provide addition material that is not bunched or hanging loose when the pleats are not expanded. The ease of movement and reduced stress provided by the pleats 40 during forward arm movement can be significant in repetitive motion activity, particularly given the weight and stiffness of the coat 10.

The raglan sleeve seam portion 36a allows for reduced use of material, and also provides freedom of movement and reduces hemrise. More particularly, the when a user wearing a standard coat lifts his or her arms upwardly, particularly above the shoulder, such movement can cause the lower edge or hem of the coat 10 to rise upwardly. The upward movement can reduce or even eliminate the overlap between the coat 10 and a wearer's trousers, thereby providing an easier path of entrance for heat, gases, fluids and the like. Sufficient hemrise in a typical coat can cause the hem to lift up above the trousers, which of course can undesirably expose the wearer to the environment. In contrast, since the raglan sleeve seam portion 36a approaches the underarm 38 of the coat 10 at an angle, when a wearer of the coat 10 lifts his or her arms, the stresses from lifting tend to be directed towards the body 12 of the coat 10, and not strictly vertically. Thus the raglan seam portion 36a tends to direct stresses from vertical arm movement in a lateral direction to reduce hemrise.

The inset sleeve seam portion 36b on the back 18 of the coat 10 allows placement of the pleats 40 in the desired position (i.e. adjacent to the sleeves 24). For example, if a raglan sleeve seam portion were to be used on the back of the coat 10, the back raglan sleeve seam portion would interfere with, or overlap with, the placement of the pleats 40 in the desired position. Thus, the raglan sleeve seam portion 36a, inset sleeve seam portion 36b, and pleats 40 all cooperate together to provide a coat 10 with reduced hemrise (i.e. the user can reach upwardly with confidence), and also provide freedom and ease of arm movement in the forward direction.

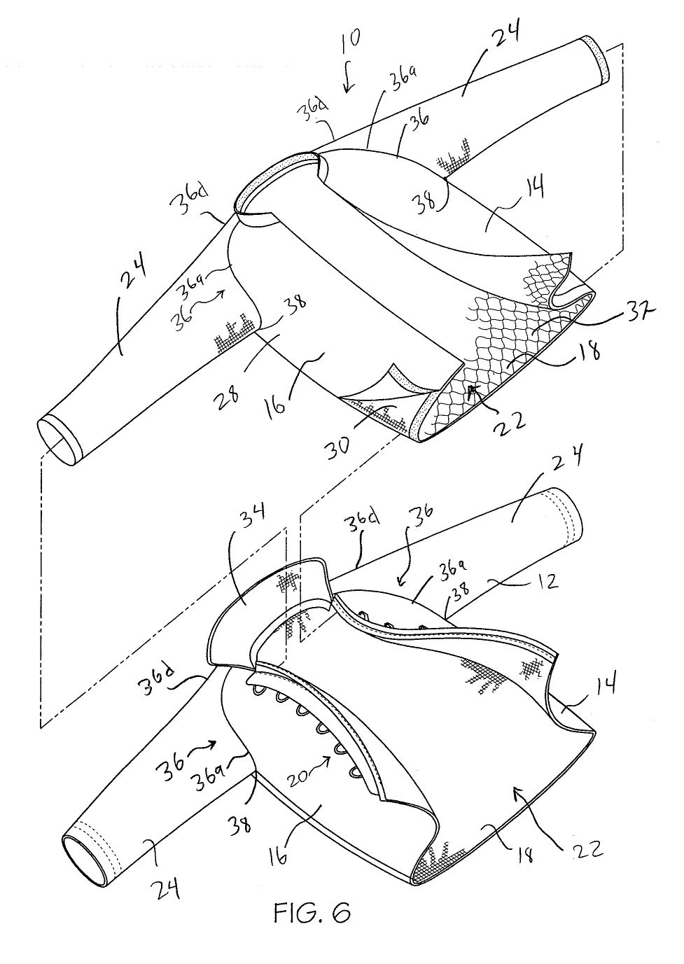

If desired, only one layer of the coat 10 (i.e. the outer shell 26) may have the hybrid seam 36 and/or pleats 40 described above. In this case the moisture barrier 28, thermal liner 30, and face cloth 32 (and any other layers) may be formed using sleeve seams different from the seam 36 on the outer shell 26. However, if desired one, some, or all of the inner layers 28, 30, 32 (or other layers) may also be made to have the seams 36 and/or pleats 40 and described herein. FIG. 6 illustrates an inner layer 28 having the same seam design 36 as the outer shell 12. The advantages provided by the sleeve design can be increased by implementing the sleeve design in the inner layers of the coat 10.

In some cases, a shoulder cap (not shown) in the form of a patch of material (i.e. the same material as the outer shell 26) may be positioned on or adjacent to the shoulder of the coat to provide additional protection to the coat 10.

Although the invention is shown and described with respect to certain embodiments, it should be clear that modifications will occur to those skilled in the art upon reading and understanding the specification, and the present invention includes all such modifications.

What is claimed is:

1. A protective garment comprising:
a body portion having a front and a back; and
a sleeve coupled to said front of said body portion by a raglan seam and coupled to said back of said body portion by an inset seam.

2. The protective garment of claim 1 further including a pleat positioned on said back of said body portion adjacent to said sleeve to provide improved freedom of movement.

3. The protective garment of claim 2 wherein said pleat is positioned generally adjacent to said inset seam.

4. The protective garment of claim 2 wherein said pleat is positioned closer to said inset seam than to a vertical center of said body portion.

5. The garment of claim 1 wherein said raglan seam includes a generally curved portion extending from an underarm portion of said sleeve to a position adjacent to a collar of said garment.

6. The garment of claim 5 wherein said raglan seam is oriented generally vertically at or adjacent to said underarm portion of said sleeve, and is oriented generally horizontally at or adjacent to said collar of said garment.

7. The garment of claim 1 wherein said inset seam extends generally vertically upwardly from an underarm portion of said sleeve and around a front of said sleeve.

8. The garment of claim 7 wherein said inset seam has a slightly concave shape.

9. The garment of claim 1 further comprising a connecting seam extending generally along a shoulder of said garment and generally circumferentially around a collar of said garment, and wherein said connecting seam thereby connects said raglan seam and said inset seam.

10. The garment of claim 9 wherein said connecting seam, said raglan seam and said inset seam together define a generally closed loop.

11. The garment of claim 1 wherein said raglan seam includes a generally curved portion extending from an underarm portion of said sleeve to a position adjacent to a collar of said garment, and wherein said inset seam extends generally vertically upwardly from an underarm portion of said sleeve around a front of said sleeve, and wherein the garment further comprises a connecting seam extending generally along a shoulder and a generally circumferentially around said collar, and wherein said connecting seam, said raglan seam and said inset seam together define a generally closed loop.

12. The protective garment of claim 1 comprising an inner layer positioned inside said body portion, wherein said inner layer includes a body portion and a sleeve coupled to a front of said body portion of said inner layer with raglan seam design and coupled to a back of said body portion of said inner layer with an inset seam design.

13. The protective garment of claim 1 comprising an inner layer positioned inside said body portion, wherein said inner layer includes a body portion and a sleeve coupled to said body portion of said inner layer with seam design that is different than the seam design by which said sleeve is attached to said body portion.

14. The garment of claim 1 further comprising a supplemental sleeve positioned on an opposite side of said body portion relative to said sleeve and coupled to said front of said body portion by a raglan seam and coupled to said back of said body portion by an inset seam, and wherein said garment has a left and a right front panel which are releasably detachable completely from each other to aid in donning or doffing said garment.

15. The garment of claim 1 wherein said garment meets National Fire Protection Association 1971 standards for protective firefighting garments.

16. The garment of claim 1 wherein body portion and sleeve include an outer shell that is abrasion, flame and heat resistant.

17. The garment of claim 16 wherein said outer shell resists igniting, burning, melting, dripping or separation when exposed to a temperature of 500° F. for five minutes.

18. The garment of claim 16 wherein said outer shell includes a material selected from a group of consisting of an aramid material, a blend of aramid materials, a polybenzamidazole material, and a blend of aramid and polybenzamidazole materials.

19. The garment of claim 16 further comprising a moisture barrier located generally inside of said outer shell such that when said garment is worn said moisture barrier is located generally between said outer shell and a wearer of said garment, said moisture barrier being made of a material that is generally liquid impermeable and generally moisture vapor permeable.

20. The garment of claim 16 further comprising a thermal liner located generally inside said outer shell such that when said garment is worn said thermal liner is located generally between said outer shell and a wearer of said garment, said thermal liner having a thermal protection performance of at least about twenty.

21. A method for making a protective garment comprising:
providing a body portion having a front and a back; and
coupling a sleeve to said front of said body portion by a raglan seam and to said back of said body portion by an inset seam.
